(19) United States
(12) Patent Application Publication
(10) Pub. No.: US 2002/0153683 A1
(43) Pub. Date: Oct. 24, 2002

(54) Steering control mechanism for folding collapsible kick scooter

(76) Inventor: Guang-Gwo Lee, Taipei (TW)

Correspondence Address: Donald C. Casey, Suite 100, 311 North Washington Street, Alexandria, VA, 22314, US

(21) Appl. No.: 09/836,232

(22) Filed: Apr. 18, 2001

(51) Int. Cl. B62M 1/00; B62D 1/00

(52) U.S. Cl. 280/87.021; 280/93.51

(57) ABSTRACT

A steering control mechanism for folding collapsible kick scooter includes a footplate having a fixed front mount, a steering control column mounted on the front mount and turned relative to the footplate between a vertical operative position and a horizontal non-operative position, and a locking mechanism adapted to lock the steering control mechanism between the vertical operation position and the horizontal non-operative position, the steering control column having a bottom yoke, the bottom yoke having two arms respectively pivoted to a transverse pivot in the front mount; the locking mechanism comprises a locking lever pivoted to the front mount above the transverse pivot and turned to lock/unlock the bottom yoke of the steering control column, the locking lever being extended over the bottom yoke and having spring means pressed on the bottom yoke after the steering control column has been turned to the operative position, and brake means provided at the bottom yoke and adapted to engage a stop face of the locking lever.

### BACKGROUND OF THE INVENTION

The present invent to folding collapsible kick scooters and, more specifically, to a steering mechanism for a folding collapsible kick scooter, which comprises a footplate having a front mount, a steering control column pivoted to the front mount below the footplate and turned between the operative position and the non-operative position, and a locking mechanism controlled to lock/unlock the steering control column.

In a conventional folding collapsible kick scooter, the steering control column is pivoted to a steering axle bearing, having a bottom yoke holding two front wheels. The steering axle bearing is pivoted to a transverse pivot on the footplate by a support arm, enabling the steering control column to be turned between the operative position and the non-operative position. German Patent DE 299 01 184 U1 discloses a locking mechanism adapted to lock the steering control column between the operative position and the non-operative position. According to this design, the support arm is fixedly provided in the shell, and a locking volt is mounted in a guide rack and supported on a spring. The spring forces the locking bolt into engagement with a hole in the rear side of the guide rack. When unlocking the steering control column, the screw bolt, which stops the spring, is pulled outwards from the guide rack, and the locking bolt is adjusted. The manufacturing cost of this complicated locking mechanism is high. Further, this locking mechanism requires much installation space, and wears quickly with use.

### SUMMARY OF THE INVENTION

The present invention has been accomplished under the circumstances in view. It is the main object of the present invention to provide a steering control mechanism for folding collapsible kick scooter, which can easily be operated with less effort to lock the steering control column between the operative position and the non-operative position. According to the present invention, the steering control mechanism comprises a footplate having a fixed front mount, a steering control column mounted on the front mount and turned relative to the footplate between a vertical operative position and a horizontal non-operative position, and a locking mechanism adapted to lock the steering control mechanism between the vertical operation position and the horizontal non-operative position, the steering control column having a bottom yoke, the bottom yoke having two arms respectively pivoted to a transverse pivot in the front mount; the locking mechanism comprises a locking lever pivoted to the front mount above the transverse pivot and turned to lock/unlock the bottom yoke of the steering control column, the locking lever being extended over the bottom yoke and having spring means pressed on the bottom yoke after the steering control column has been turned to the operative position, and brake means provided at the bottom yoke and adapted to engage a stop face of the locking lever. The locking lever is pivoted to a pivot in the front mount of the footplate above the elevation of the transverse pivot to which the bottom yoke of the steering control column is pivoted, and turned to lock the steering control column between the operative position and the non-operative position. After the steering control column has been turned to the operative position, the locking lever extends over the bottom yoke of the steering control column, and forced by a spring against the bottom yoke to lock the steering control column in the operative position. The bottom yoke of the steering control column has a brake adapted to engage a stop face of the locking lever. When unlocking the steering control column, the locking lever is pulled outwards to release the spring to disengage the brake from the stop face, for enabling the steering control column to be turned from the operative position to the non-operative position. A common brake is used to lock the bottom yoke of the steering control column. The turning angle of the locking lever must be greater than the turning angle of the steering control column. Further, the brake has a cam to achieve clearance-free locking operation. When locked, the cam of the brake is kept in close contact with the stop face. In order to simplify the structure, the bottom yoke stop face and the brake are formed of a flange at one side of the locking lever or a rod member protruded from one side of the flange. By means of using the flange or rod member, the desired stop face and brake are provided to receive the load. In order to minimize the structural height, the transverse pivot to which the steering control column is pivoted is disposed below the elevation of the footplate, and the pivot to which the locking lever is pivoted is disposed above the elevation of the footplate.

### BRIEF DESCRIPTION OF THE DRAWINGS

FIG. 1 is a top view of a steering control mechanism for folding collapsible kick scooter according to the present invention.

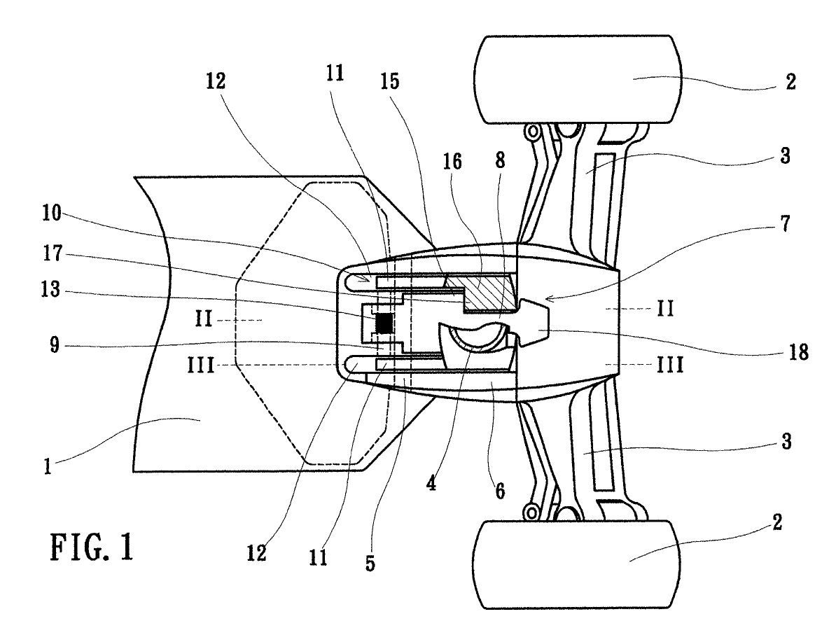

FIG. 2 is a sectional view taken along line II-II of FIG. 1.

FIG. 3 is a sectional view taken along line III-III of FIG. 1 showing the steering control column collapsed.

### DETAILED DESCRIPTION OF THE PREFERRED EMBODIMENT

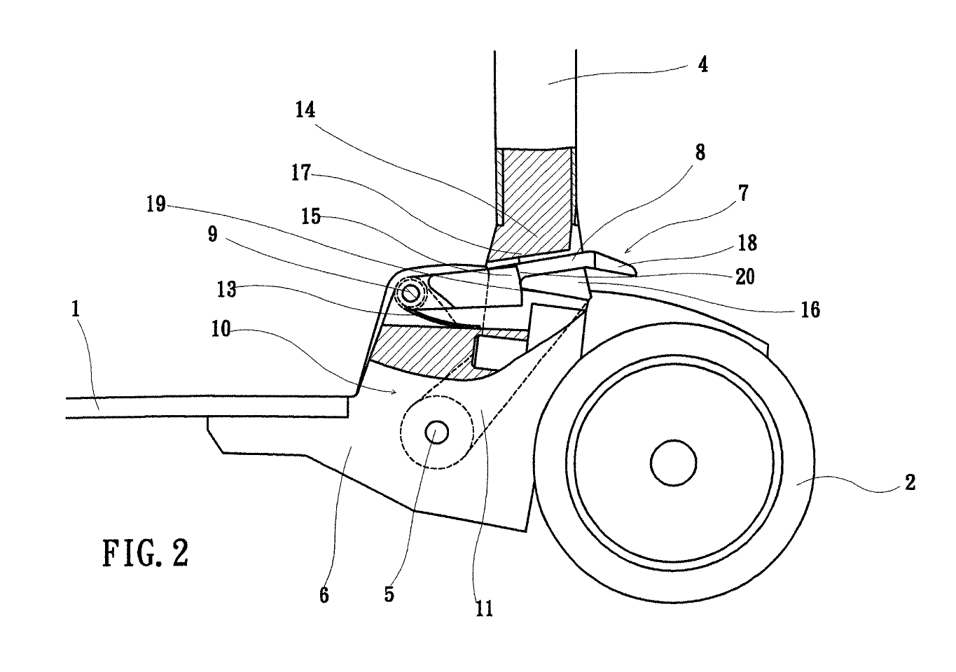

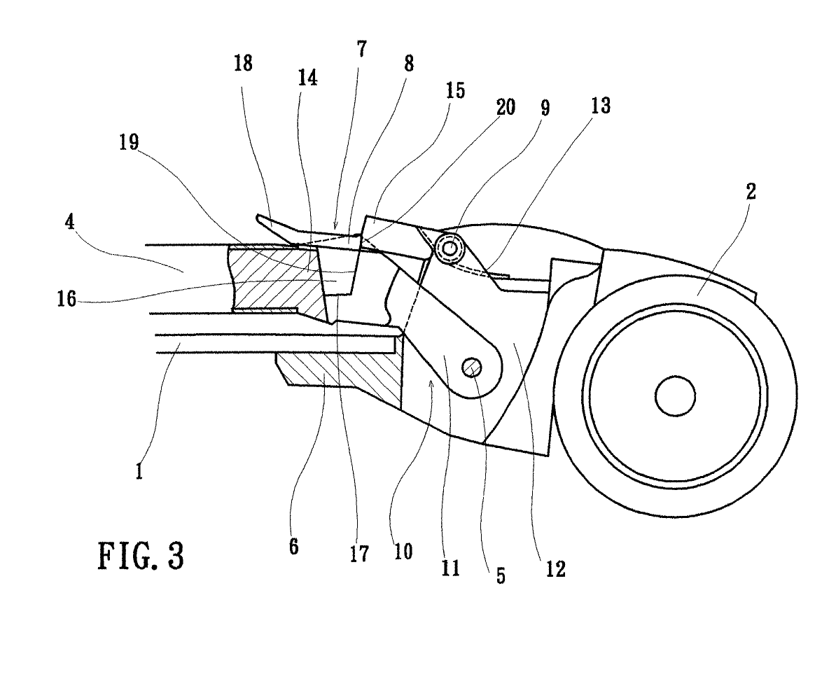

Referring to FIGS. from 1 through 3, a steering control mechanism for a folding collapsible kick scooter in accordance with the present invention is generally comprised of a footplate 1, a mount 6 fixedly fastened to the front side of the footplate 1, a steering control column 4 pivoted to the mount 6 by a pivot 5, a front wheel frame 3 fixedly fastened to the bottom end of the steering control column 4 to hold two front wheels 2 and turned leftwards/rightwards with the steering control column 4, a locking mechanism 7 controlled to lock the steering control column 4 between the vertical position (the operative position) shown in FIG. 2 and the horizontal position (the non-operative position) shown in FIG. 3. The locking mechanism 7 comprises a pivot 9 transversely mounted in the mount 6 above the pivot 5, and a locking lever 8 turned about the pivot 9 to lock/unlock the steering control column 4.

The steering control column 4 comprises a yoke 10 supported on the pivot 5. The yoke 10 comprises two arms 11 inserted into the mount 6 as shown in FIG. 2. After the steering control column 4 has been set in the working position, the locking lever 8 is extended over the yoke 10, and forced against a flange 14 between the arms 11 of the yoke 10 by a torsional spring 13. When in the locking position as shown in FIG. 2, a brake 15 is stopped against a stop face 17 of a flange 16. When releasing the spring 13 from the locking lever 8, a handle 18 is turned to disengage the brake 15 from the stop face 17, for enabling the steering control column 4 to be turned about the pivot 5 to the collapsed position. The yoke 10 can be turned about the pivot 9 toward the backside through about 180° to force the brake 15 into contact with the stop face 19. At this time, the steering control column 4 is locked, and can be turned back to the operative position only after unlocking the locking lever 8.

In order to achieve tight locking of the steering control column 4, the brake 15 of the locking lever 8 has a cam 20 adapted to stop against the stop face 17 or 19, enabling the locking lever 8 to lock the steering control column 4 between the operative position and the collapsed position.

A prototype of steering control mechanism for folding collapsible kick scooter has been constructed with the features of the annexed drawings. The steering control mechanism for folding collapsible kick scooter functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A steering control mechanism for folding collapsible kick scooter comprising a footplate having a fixed front mount, a steering control column mounted on said front mount and turned relative to said footplate between a vertical operative position and a horizontal non-operative position, and a locking mechanism adapted to lock said steering control mechanism between said vertical operation position and said horizontal non-operative position, wherein said steering control column comprises a bottom yoke, said bottom yoke having two arms respectively pivoted to a transverse pivot in said front mount; said locking mechanism comprises a locking lever pivoted to said front mount above said transverse pivot and turned to lock/unlock said bottom yoke of said steering control column, said locking lever being extended over said bottom yoke and having spring means pressed on said bottom yoke after said steering control column has been turned to said operative position, and brake means provided at said locking lever and adapted to engage a stop face of said bottom yoke.

2. The steering control mechanism of claim 1 wherein said bottom yoke comprises two stop faces arranged at right angles and working with a common locking lever brake.

3. The steering control mechanism of claim 1 wherein the brake of said locking lever comprises a cam turned with said locking lever about a pivot in said front mount.

4. The steering control mechanism of claim 1 wherein the brake face of said bottom yoke and said brake are formed of a flange at one side of said locking lever or a rod member protruded from said yoke.

5. The steering control mechanism of claim 1 wherein said transverse pivot to which said steering control column is pivoted is installed in said front mount below said footplate, and the pivot to which said locking lever is pivoted is installed in said front mount above said footplate.
